(19) United States
(12) Patent Application Publication
(10) Pub. No.: US 2004/0081861 A1
(43) Pub. Date: Apr. 29, 2004

(54) Fuel cell power generating systems for recreational vehicles

(76) Inventor: Iraj Parchamazad, La Verne, CA (US)

Correspondence Address: Patrick F. Bright, 633 West Fifth Street, # 3330, Los Angeles, CA, 90071, US

(21) Appl. No.: 10/281,584

(22) Filed: Oct. 28, 2002

(51) Int. Cl. H01M 8/00

(52) U.S. Cl. 429/12; 429/20; 429/26

(57) ABSTRACT

Fuel cell power systems adapted for use in recreational vehicles include a fuel cell and, optionally, a fuel processor, together with appropriate electronics and balance of plant, that co-generate electricity, heat and water from fuels such as propane. The fuel cell power system supplies such a vehicle with electrical power, heat and water.

This invention relates to fuel cell power systems, and more particularly, to fuel cell power systems adapted for use in recreational vehicles.

This invention is related to the subject matter of commonly-owned, U.S. Pat. No. 6,352,792 B1, issued Mar. 5, 2002, and entitled “Portable Co-generation Fuel-Cell Power Generator for Recreational Vehicles; to pending U.S. patent application Ser. No. 09/537,903, filed Mar. 17, 2000, and entitled “Holmium Based Catalyst for Producing Hydrogen”; to pending U.S. patent application Ser. No. 09/552,287, filed Apr. 19, 2000, and entitled “Purifier of Hydrogen From Reformer for Fuel Cell”; and to pending U.S. patent application Ser. No. 09/973,287, filed Oct. 5, 2001, and entitled “Portable Co-generation Fuel-Cell Power Generator With High-Yield, Low-Pressure Reformer For Recreational Vehicles”. The disclosures of this issued U.S. patent, and of these pending U.S. patent applications, are incorporated herein by reference in their entirety as if fully set forth here.

These fuel cell power systems comprise a fuel cell, and may also include a fuel processor, appropriate electronics and balance of plant. Together, the fuel processor and fuel cell form a co-generation system for electricity, heat and water. The fuel processor produces hydrogen and heat. Heat from the fuel processor may be used for heating water or air, as, for example, in space heating. The fuel processor can extract hydrogen from any suitable source, such as hydrocarbons, alcohols or other hydrogen-containing compounds, e.g. methane, CNG, ethane, propane, LPG, gasoline, diesel fuel, kerosene, and methanol.

In general, the fuel processor system comprises a reformer and purifier of suitable kinds for producing relatively pure hydrogen for use in the fuel cell. The reformer may, for example, be a steam reformer or a pyrolysis cracker.

The fuel cell uses hydrogen from the fuel processor as a fuel to produce electrical power, and a gas/water mixture. Water may be separated from this mixture in a liquid/gas separator, e.g. a centrifugal separator. The fuel cell also generates heat. This heat may be used to heat water or air.

This invention also contemplates the use of a direct-fuel fuel cell such as a direct methanol or propane fuel cell. Such fuel cells utilize fuel such as methanol and propane directly, without a reformer to produce hydrogen.

In a preferred embodiment, the fuel cell power generating system is incorporated into a recreational vehicle. The fuel cell power system furnishes such a vehicle with electrical power, heat, and water. Optionally, the electrical power generated in the system may, for example, be converted, as necessary, to a voltage suitable for charging the battery of a recreational vehicle, or may be directed for use outside such a recreational vehicle.

In preferred embodiments, heat from the fuel cell is carried from the fuel cell in a circulating coolant such as water. The coolant carries the heat from the fuel cell to a heat exchanger. There, heat is removed from the coolant with air or another medium. For example, a forced air fan may remove the heat from the coolant, and direct the heat through appropriate ducting into a recreational vehicle for heating the vehicle.

In addition to electrical power, the fuel cell also produces water. This water may be collected and used in a recreational vehicle in several ways. Preferably, the water produced in the fuel cell exits the fuel cell as a humid air/oxidant exhaust mixture. This exhaust passes to a gas/liquid separator, such as a centrifugal separator where water is extracted from the exhaust. The extracted water drains into a reservoir. From the reservoir, the water may pass to a fuel cell coolant reservoir, and then may be pumped into a fresh water holding tank in a recreational vehicle.

If the fuel cell does not consume all of the hydrogen produced by the fuel processor, the unused hydrogen may be collected in a reservoir. Fuel cell purge gas, if any, together with the flammable gas mixture, rejected from the hydrogen purifier may be collected in the same reservoir, for example, by using a compressor. Alternatively, these rejected gases and gas mixtures need not be mixed with other gases, but instead may be sent directly to a burner. These gases are good fuels, and may be burned to generate heat for such uses as water heating, air/space heating, and refrigeration.

When the fuel cell includes a fuel reformer, the reformer's cover may, for example, take the form of a heat exchanger shell. Such a shell preferably comprises two machined metal pieces joined face-to-face. Grooves/bends formed in these pieces form one or more small channels around the shell. Preferably, these channels form a single, continuous channel around the cell, producing a good flow pattern. Preferably, the shell includes an inlet near one end, and an outlet near the other end of the shell, to allow media such as cool water to enter, and media such as warm water to exit.

This invention contemplates using a fuel cell with or without internal reforming, e.g. polymer electrolyte membrane (PEM), phosphoric acid, alkaline, solid oxides, or molten carbonate fuel cells, to produce electricity. Alternatively, the system may omit the fuel processor, and include instead a source of relatively pure hydrogen such as compressed hydrogen, metal hydrides, or a nanotube storage system.

Because the reforming reaction in the fuel processor consumes heat, a burner is necessary to heat the catalyst beds in the reformer. This burner produces hot exhaust gases which become a heat source. The system removes this heat from the exhaust, and may use the heat to warm water for a recreational vehicle, thus replacing the vehicle's propane fuel hot water heater, at least in part. Hot exhaust gases may be used for preheating fluids such as water for steam generation.

Recreational vehicles often have an awning or other covering at one side of the vehicle. When raised, this covering forms a porch area alongside the vehicle. The porch area may be used for such activities as sleeping and eating. The system of this invention can be used to provide heat to this porch area. The heat source for the porch area may be any of the above mentioned co-generation items from the fuel cell power system.

In preferred embodiments, the recreational vehicle may include a vent, e.g. a multidirectional louvered register, on the patio side of the vehicle. Alternatively, the vent may be connected to ducting to convey heat from the vehicle to a location distant from the vehicle patio, and for heating pipes and other surfaces located beneath such a vehicle.

### BRIEF DESCRIPTION OF THE DRAWINGS

The invention can better be understood by reference to the drawings, in which:

FIG. 1 is a block function diagram showing the components of an embodiment of a fuel cell power system;

FIG. 2 shows the location of the fuel cell power system components of FIG. 1 on the chassis of a recreational vehicle;

FIG. 3 is a diagram illustrating the use of heat from a fuel cell, such as the fuel cell in FIG. 1;

FIG. 4 shows water recovery from a fuel cell, such as the fuel cell shown in FIG. 1;

FIG. 5 shows the use of reformer rejected flammable gas and fuel cell purge gas as a fuel source to generate heat or warm water;

FIG. 6 shows recovery and use of reformer heat in a system such as shown in FIG. 1;

FIG. 7 shows the use of reformer exhaust heat; and

FIG. 8 shows how a fuel cell power system can heat the patio area bside a recreational vehicle.

### DETAILED DESCRIPTION OF THE DRAWINGS

FIG. 1 shows fuel cell power system 10 which includes fuel processor 11 and fuel cell 12. Fuel processor 11 produces hydrogen which is delivered on path 13 to fuel cell 12. Fuel processor 11 extracts hydrogen from fuel source 14. Fuel is delivered on path 15 to fuel cell 11 from source 14. Suitable fuels are methane, CNG, ethane, propane, LPG, gasoline, diesel, kerosene, and methanol. Fuel cell 12 consumes hydrogen and outputs electrical power on path 16 to electrical power source 17. Fuel cell 12 also produces water on path 12A, leading to reservoir 12B.

Fuel processor 11 and fuel cell 12 both produce heat which may be used to heat air or water. Heat passes from fuel cell 12 on path 18 to heat source 19. From source 19, heat passes on path 20 to heat water at 21, and on path 23 to heat air at 22. From fuel processor 11, heat passes on path 24 to heat source 25. From source 25, heat passes on path 26 to heat water at 27, or on path 28 to heat air at 29, or both.

In FIG. 4, water from fuel cell 12 passes on path 30 to air/water separator 31. Separator 31, which may be a centrifugal separator, produces air of lower humidity on path 32 and water on path 33. Water on path 33 passes to reservoir 34. From reservoir 34, water passes on path 35, under the influence of pump 36, through filter 37, and then passes on path 38 to fuel cell water reservoir 39. Water also passes on path 40, under the influence of pump 41, through filter 42. From filter 42, filtered water passes on path 43 to water storage tank 44.

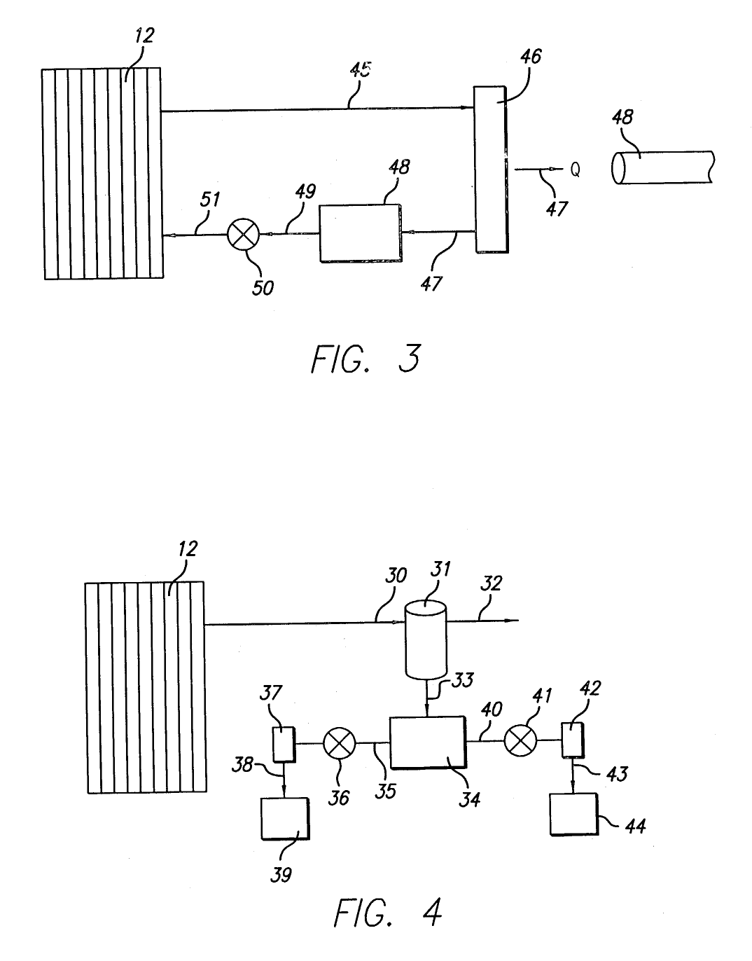

FIG. 3 illustrates how the system may recover heat from fuel cell 12. In FIG. 3, fuel cell 12 includes a circulating coolant system which removes heat from fuel cell 12. This coolant passes on path 45 to heat exchanger 46. There, heat is extracted from the coolant using air to entrain heat. The extracted heat appears on path 47, and passes through ducting 48 for use, e.g. in heating the interior of a recreational vehicle. Coolant passes from heat exchanger 46 on path 47 into coolant reservoir 48. From reservoir 48, coolant passes on path 49 under the influence of pump 50, on path 51 to fuel cell 12.

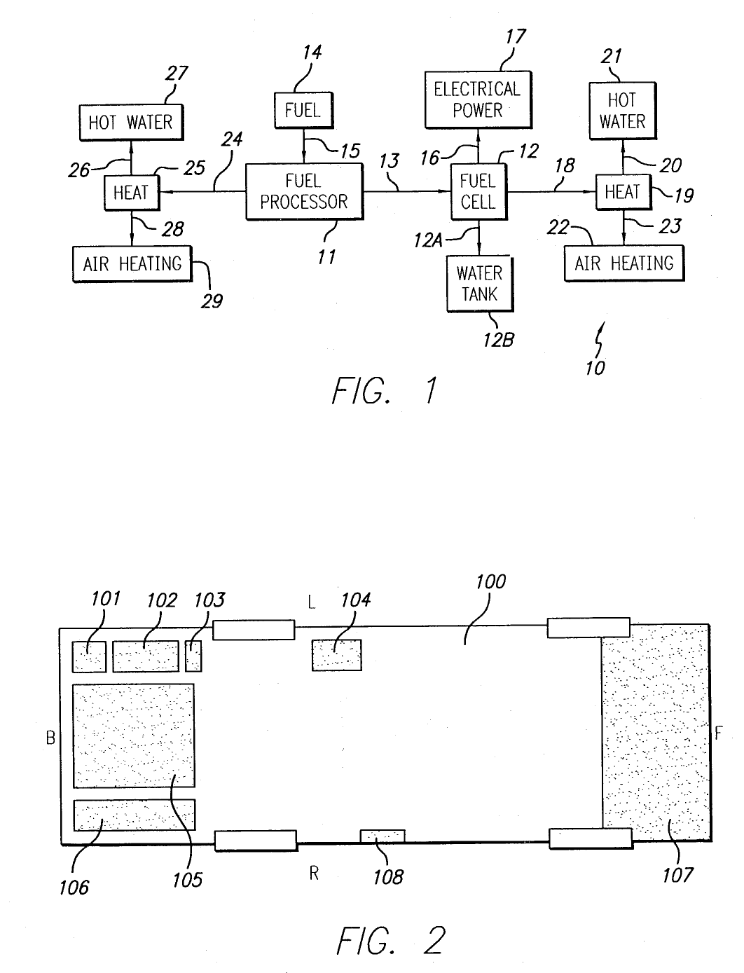

FIG. 2 shows, by way of example, the location of fuel cell power system components on recreational vehicle chassis 100. Fuel cell 101 and a fuel processor, here reformer 102, are located near the back of vehicle chassis 100 adjacent supplemental burner heater 103. Near burner heater 103 is hot water heater and tank 104. Also near the back of vehicle chassis 100 are fresh water tank 105 and fuel tank 106. Near the front end of vehicle chassis 100 is drive engine 107. At the side of vehicle 100 is air vent 108. Vent 108 delivers hot air to a patio area alongside vehicle chassis 100.

FIG. 5 illustrates the use of reformer rejected flammable gas and fuel cell purge gas as a fuel source. Hydrogen from fuel processor 11 passes on path 201 to gas pressurization/accumulation reservoir 202. From fuel cell 12, anode purge gas, if any, passes on path 203 to reservoir 202. From reservoir 202, a mixture of hydrogen and anode purge gas passes on path 204 through electromagnetic valve 205. Valve 205 is triggered when the pressure in reservoir 202 rises above a predetermined level. This gas mixture passes to burner 206 when the fuel burns to produce heat at 207. This heat passes through heat exchanger 208, and is entrained in heat exchanger fluid at 209. The heat exits from heat exchanger 210 on path 211.

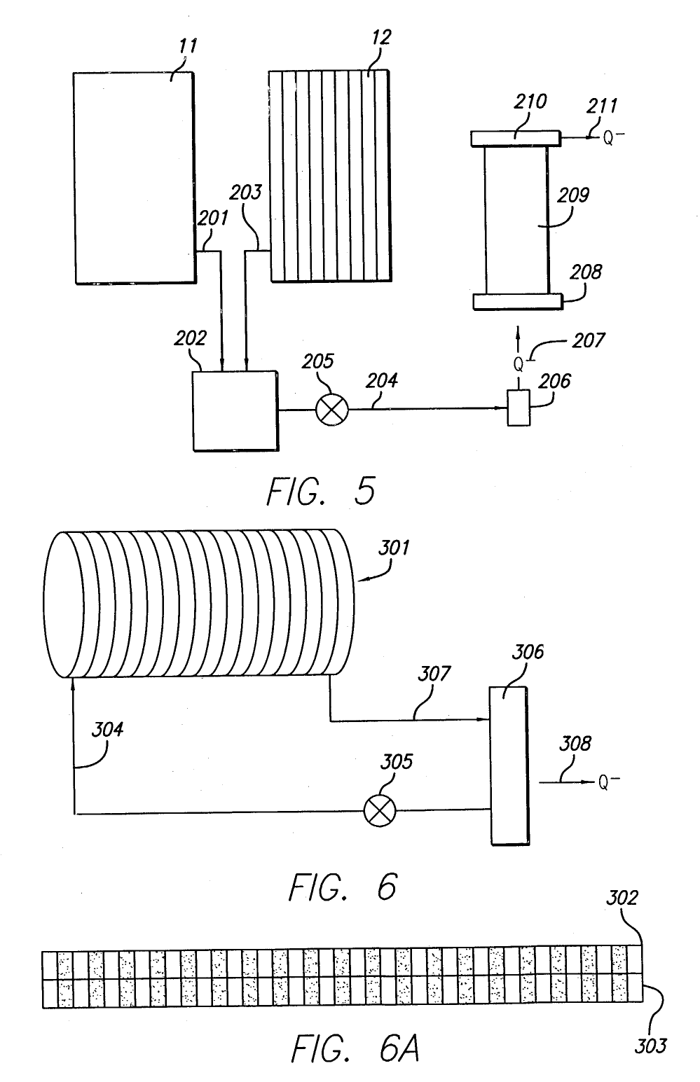

FIG. 6 shows recovery and use of heat from the reformer. The reformer cover is heat exchanger shell 301, but may be of any suitable type. Shell 301 is formed by joining two sheets of machined metal 202 and 203 face-to-face; see FIG. 6A. Shell 301 includes a circumferential, continuous path for liquid flow around shell 301. Cooler heat exchange media enters shell 301 on path 304. Path 304 includes pump 305. Pump 305 pumps heat exchange media from heat exchanger 306 to shell 301. Heated heat exchange media exits shell 301 on path 307, and passes to heat exchanger 306. There, heat is extracted and output on path 308.

FIG. 7 shows the utilization of reformer exhaust heat. Exhaust exits fuel processor 11 on path 401. The exhaust gases on path 401 pass through heat exchanger 403. There, heat is extracted with a cooling medium. Extracted heat is carried on path 407 to heat exchanger 405 and hot water tank 406. From there, water returns to heat exchanger 403 on path 408 under the influence of circulating pump 404. Exhaust gases on path 402 are useful as a heat source.

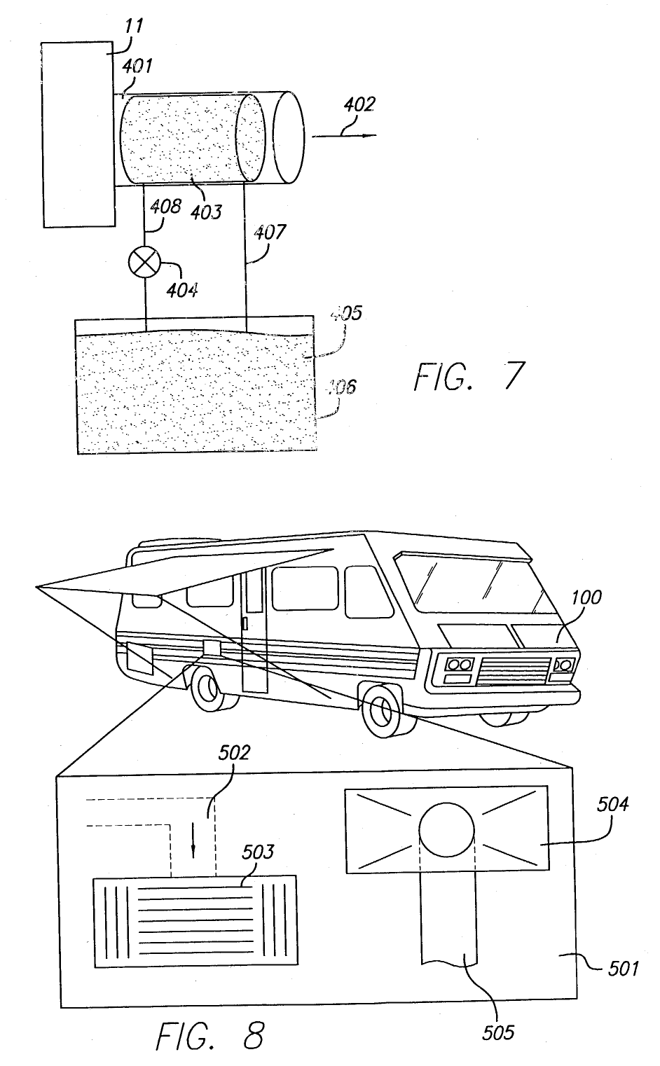

FIG. 8 shows patio area 501 alongside a recreational vehicle 100. Heat from any of the sources discussed above passes on path 502 through louvered vent 503 at the side of vehicle 100 or, alternatively, passes through fitting 504 and duct 505 to the patio or to another area.

What is claimed:

1. A recreational vehicle Comprises a fuel cell power system mounted on said vehicle for providing electrical power, heat and water to said vehicle, said vehicle comprising a hydrogen-powered fuel cell mounted on said vehicle, a system for delivering relatively pure hydrogen to said fuel cell, a path from said fuel cell for delivering electrical power to said vehicle, a path from said fuel cell for delivering water to said vehicle, and a path from said fuel cell for delivering heat to said vehicle.

2. The vehicle of claim 1 further comprising a fuel processor that delivers relatively pure hydrogen to said fuel cell, said fuel processor being mounted on said vehicle.

3. The vehicle of claim 1 further comprising outlets for delivering heated air derived from said fuel cell to areas alongside said vehicle.

4. The vehicle of claim 1 further comprising heat exchanger means for extracting heat from the heat output of said fuel cell, and for entraining said heat in air for delivery to said vehicle.

5. The vehicle of claim 1 further comprising a separator linked to the water outlet of said fuel cell for extracting water from the air-water mixture from said fuel cell.

6. The vehicle of claim 1 further comprising a fuel cell processor connected to said fuel cell, and a reformer in said fuel processor, said reformer producing said relatively pure hydrogen.

7. The vehicle of claim 1 further comprising a fuel processor, and a reformer in said fuel processor, said vehicle further including a heat exchanger that extracts heat from said fuel processor, and then delivers said heat through appropriate paths to desired areas of said vehicle.

8. The vehicle of claim 1 further comprising storage for relatively pure hydrogen mounted on said vehicle, said storage being linked to said fuel cell for delivery of relatively pure hydrogen to said fuel cell.

9. The vehicle of claim 1 wherein said fuel cell is a direct-fuel fuel cell, and wherein said vehicle includes a storage system for said direct-fuel mounted on said vehicle.

10. The vehicle of claim 1 further comprising a storage facility for storing liquified propane aboard said vehicle.

11. The vehicle of claim 1 further comprising a fuel processor, said fuel processor generating heat and rejected flammable gases.

12. The vehicle of claim 11 wherein said fuel processor further comprises a hydrogen purifier.

13. The vehicle of claim 1 further comprising a fuel processor, said fuel processor including a hydrogen purifier.

14. The vehicle of claim 13 further comprising a gas accumulation reservoir that receives rejected flammable gases from said hydrogen purifier, and rejected hydrogen and other flammable gases from said fuel cell, for use in a burner device for producing heat.

15. The vehicle of claim 1 further comprising fuel cell electronics and balance of plant for said fuel cell.

16. The vehicle of claim 1 further comprising a path from said fuel cell to a converter for changing the voltage, amperage, or both, of electrical power from said fuel cell, and from said converter, a path to power-consuming means within or outside of said vehicle.

17. The vehicle of claim 1 further comprising a fuel cell selected from the group consisting of polymer electrolyte membrane, phosphoric acid, alkaline, solid oxides, and molten carbonate fuel cells, or, alternatively, absent a fuel processor, further comprising a source of relatively pure hydrogen, metal hydrides, or a nanotube storage system.
